(19) United States
(12) Patent Application Publication
(10) Pub. No.: US 2020/0011115 A1
(43) Pub. Date: Jan. 9, 2020

(54) VERTICAL SLIDING WINDOW FOR A BUILDING

(71) Applicant: BHB GmbH, Oberhaid (DE)

(72) Inventor: Raimund Stark, Oberhaid (DE)

(21) Appl. No.: 16/490,264

(22) PCT Filed: Mar. 5, 2018
(86) PCT No.: PCT/IB18/00182

§ 371 Date: Aug. 30, 2019

(30) Foreign Application Priority Data
Mar. 3, 2017 (EP) 17000344.6

(51) Int. Cl. E06B 3/44; E06B 9/54; E06B 9/40

(52) U.S. Cl. CPC E06B 3/4423; E06B 2009/2447; E06B 9/40; E06B 9/54

(57) ABSTRACT

The invention is directed to a vertical sliding window as a closure for an opening in an exterior wall of a building, wherein for opening, at least one window pane of the sliding window may be lowered downwardly, in particular into a flat chamber within a box. The sliding window may be provided as a finished module, with the option of integrating insulation and/or designing the facade; it is also possible to integrate a roller shutter box, in particular also in heat-insulated form. The area of application for such a sliding window component ranges from single-family dwellings to high-rise buildings of any conceivable height.

### REFERENCE TO PENDING PRIOR PATENT APPLICATIONS

This patent application claims benefit of International (PCT) Patent Application No. PCT/162018/000182, filed 5 Mar. 2018 by BHB GmbH for VERTICAL SLIDING WINDOW FOR A BUILDING, which claims benefit of European Patent Application No. EP 17000344.6, filed 3 Mar. 2017, which patent applications are hereby incorporated herein by reference.

### FIELD OF THE INVENTION

The invention is directed to a vertical sliding window as a closure for an opening in an exterior wall of a building, wherein all superposed, movable window panes of the sliding window are an integral part of a single sliding sash, which for opening may be lowered vertically downwardly as a whole, and may be completely or essentially completely countersunk into a flat chamber within a box.

### BACKGROUND OF THE INVENTION

With customary pivoting windows, the opened pivoting sashes objectionably protrude into the room in question, which unfavorably restricts freedom of movement in the room.

Therefore, consideration has been given to designing a window sash to be vertically displaceable in its plane. In particular, it has been proposed in U.S. Pat. No. 2,525,322 to insert into a window opening a window having two sashes, which in the closed state of the window are situated one on top of the other. The lower sash may then be moved vertically upwardly, if needed, until it is approximately aligned with the upper sash. The lower half of the window is then open without a sash protruding into the room in question. However, the opening thus created is only approximately half as large as the wall opening between the lintel and the window sill, which in some situations is not adequate. Lastly, the lower edge of the two window sashes, which is always visible, is perceived as having an objectionable appearance, since it passes through the clearance, i.e., transparent, area of the actual window panes.

Due to the design used by the invention, a window may be opened without interfering with freedom of movement in the interior of a room. Thus, in the case of moderate outside temperatures, i.e., in warmer latitudes and/or in the warm time of year or transition periods, there is an option for leaving a window open for an extended period of time so that the room in question is always well ventilated. However, it has since become known that extensive ventilation is not always advantageous for the room in question. This is because suspended particles, whose quantity and composition vary depending on the surroundings, time of day and year, and weather conditions, are always present in the air. These range from desert sand (which under certain weather conditions can be carried anywhere, for example from the Sahara to central Europe), to road dust, pollen, and other allergens, as well as various aerosols, soot from blast furnaces and a variety of combustion processes, and other fine particulate matter. If these substances penetrate into living areas, they can cause various adverse effects: while sand and dust “only” settle on furniture and form a layer of dust that can be removed only with great effort, for a large portion of the population pollen and other allergens are much more unpleasant, and may trigger coughing as well as asthma attacks, let alone soot and other fine particulate matter, which are respirable and can accumulate in the lungs, and in the worst case may even have carcinogenic effects. Furthermore, suspended particles may also transport chemically irritating or even toxic materials or radioactive substances into the lungs, where their adverse health effects may develop. There are typical combinations for the particular composition of suspended particles. For example, primarily soot and other fine particulate matter are found in urban centers due to the high traffic volume; in contrast, in the countryside, i.e., far away from urban centers, pollen is primarily found in fertile areas, and in arid regions, principally sand and dust.

### SUMMARY OF THE INVENTION

The disadvantages of the described prior art have resulted in the object underlying the invention, to refine a generic vertical sliding window in such a way that when the window is open, the opened window sash does not protrude into the room, so that with moderate outside temperatures continuous ventilation is possible, and at the same time the aim is to provide the option for protecting the room in question from excessive penetration of suspended particles.

The object is achieved in that the free lower edge of a filter mat is suspended or suspendable on the upper edge of the sliding sash, and is suitable for filtering suspended particles such as fine sand, dust, soot, aerosols, allergens, or fine particulate matter and may be unwound from a shaft that is installed above the closed sliding sash.

The chamber for accommodating the lowered window sash in a box, provided for this purpose, is situated below the actual window, i.e., beneath a window sill, provided that a window sill is present. This chamber is preferably closed on the shell side except for a narrow slot on its top side, through which the window pane in question may be pushed upwardly out of the chamber or lowered downwardly into the chamber in question. The walls of this chamber may be made of plastic or metal, in particular sheet metal. Due to the fact that the slot at the upper end of the chamber may be sealed off from the pane, which extends downwardly to a greater or lesser degree into the slot, for example with a sealing strip in each case made of rubber or some other soft material, suspended particles cannot access this area. Thus, at best they may penetrate into the room in question through the opening left by the completely or partially lowered window pane. To prevent the penetration of suspended particles at this location as well, according to the invention the option is provided for closing off the window opening above the upper edge of the pane via a filter mat. This filter mat is designed in such a way that air exchange is possible, but suspended particles are retained to the greatest extent possible. It should be noted that the various suspended particles have different sizes. Sand grains have a diameter of approximately 1 mm, while dust particles are much smaller. Pollen typically has dimensions between 10 μm and 100 μm, and fine particulate matter has even smaller dimensions, usually less than 5 μm into the nanometer range. It is not necessary for every application to filter all suspended particles. As indicated above, this also depends on the location of use of the window in question, with a distinction being made between arid regions and fertile areas and even urban centers. In the first-mentioned case, a filter should be able to retain suspended particles having a size of 100 μm or greater; in fertile areas, suspended particles having a size of 10 μm to 100 μm should be retained, and in urban centers, suspended particle having a size of less than 10 μm, for example down to 1 μm or even smaller, if possible. Thus, within the scope of the invention, various embodiments may be provided that differ in the characteristics of the filter mat. The filter mat is preferably a very finely meshed fabric with a mesh size of less than 1 mm, for example a mesh size of 500 μm or less, or 200 μm or less, preferably with a mesh size of 100 μm or less, for example a mesh size of 50 μm or less or 20 μm or less, or even with a mesh size of 10 μm or less. To improve the filtering effect, the fabric, which preferably is made of synthetic fibers such as polyester or Nylon fibers, or glass filaments, in particular individual glass filaments, may be roughened on at least one side and/or provided with a coating to improve the adherence of suspended particles. To improve the transparency despite the fine-mesh structure, it may be further provided that the intersecting threads have a different mesh size in one direction than in a direction transverse thereto, for example more than twice the mesh size in one direction than in a direction transverse thereto, or at least three times, or at least four times, the mesh size in one direction. In such cases, the clear cross section is increased, while the mesh size, at least in one direction, is sufficiently small to also be able to retain small suspended particles. Additional measures may be provided for filtering fine particulate matter or soot, such as arranging two or more such fabric mats parallel to one another in direct contact, wherein the orientation of the threads of two fabric mats may preferably be rotated by 45° relative to one another, or for three fabric mats, by ±30° relative to a middle fabric mat.

The invention further provides that two straight, preferably mutually parallel longitudinal edges of the filter mat web adjoin the free lower edge of the filter mat, and connect the free lower edge of the filter mat to the shaft, and in each of which a lateral guide and/or seal extends. The primary task of a guide is to hold the filter mat at its intended position, even under wind pressure, while the seal is responsible for tightly sealing off the filter mat from the inner side of the window casing, in order to prevent penetration of suspended particles at that location as well.

For this purpose, it has proven useful for the lateral guide and/or seal for the filter mat to have a U-shaped cross section whose opening faces the filter mat. The unwound filter mat preferably engages with this opening on the edge side, and undergoes guiding therein.

The guide and the seal may be integrated with one another by providing one or both inner sides of the opening of a lateral guide with a rubber seal or a brush seal.

The invention may be further refined in that the free lower edge of an insect screen or a horizontal rod fixed thereto is suspended or suspendable on the upper edge of the sliding sash, wherein the insect screen may be unwound from a shaft installed above the closed sliding sash. The filter mat on the one hand keeps out suspended particles, but on the other hand, due to its fine-mesh structure, may also limit the air flow rate and possibly interfere somewhat with visibility to the outside. If these factors under certain circumstances outweigh the retention of suspended particles, but the penetration of pests is still to be avoided, instead of the filter mat an insect screen may be used which is suspended on the upper edge of the lowerable pane. An insect screen has a much larger mesh size than a filter mat according to the invention; whereas a filter mat according to the invention has a mesh size less than 1 mm, for example a mesh size of 500 μm or less or 200 μm or less, preferably a mesh size of 100 μm or less, for example a mesh size of 50 μm or less or 20 μm or less, or even a mesh size of 10 μm or less, an insect screen according to the invention should have a mesh size of at least 1 mm or greater, preferably a mesh size of 1.2 mm or greater, in particular a mesh size of 1.4 mm or greater, so that a sufficient air flow rate and good transparency are ensured.

Within the scope of the invention, at least one shaft from which the filter mat and/or the insect screen may be unwound is supported within an upper, horizontal closure element, wherein a shaft that accommodates the filter mat and/or the insect screen is preferably pretensioned by a spring element in a rotational direction such that the spring element seeks to wind up the filter mat and/or the insect screen.

The shaft(s) should be displaced perpendicularly with respect to the plane of the window pane, so that a thin filter mat is provided with its own seal in addition to the lateral guides for the window pane having a different thickness.

The free end of the filter mat and/or of the insect screen, when it is detached from the particular shaft in an area facing the window pane, may engage there with the guide provided for this purpose close to the guide for the window pane, so that further deflection of the filter mat or of the insect screen is not necessary.

The invention is further characterized by a first shaft for the filter mat and a second shaft for the insect screen. Due to winding up two separate shafts, the filter mat on the one hand and the insect screen on the other hand may be unwound and used independently of one another. It is thus possible to use only the filter mat, or only the insect screen, or both at the same time.

Further advantages result from the fact that the filter mat is wound onto the first shaft in an opposite winding direction than the insect screen is wound onto the second shaft. It is thus possible for the two shafts to be situated at opposite sides of the window pane, i.e., one outside the window pane and the other inside it.

If a window according to the invention is equipped with both a filter mat and an insect screen, it is recommended that the insect screen be situated on the inner side of the filter mat. On the one hand it is thus possible that when both are used, the generally stronger insect screen can additionally support the filter mat against the wind pressure; on the other hand, when it rains the filter mat may then be automatically cleaned by the washing away of adhering particles.

There is a further option that for cleaning purposes, the shaft with the filter mat and/or the shaft with the insect screen are/is removable, and/or the filter mat and/or the insect screen are/is removable from their/its respective shaft(s). In the latter case, the particular filter web or screen web may even be washed in a washing machine.

If a spring tensioning element for the first shaft is situated opposite from the spring element for the second shaft so as to act in a reverse direction of rotation, an arrangement is supported, with the two shafts situated on different sides of the window pane.

According to one preferred design rule, lateral guides for the insect screen are situated on the side of the guides for the filter mat that face the interior. This corresponds to the arrangement discussed above, in which an interior insect screen can support the filter mat against external effects of wind pressure. On the other hand, a reverse arrangement may possibly be selected, with the filter mat then being situated on the side of the insect screen facing the interior.

According to the invention, an arrangement is preferred in which the free lower edge of the filter mat or a horizontal rod fixed thereto is suspended or suspendable in the area of the outer side or in the area of the inner side of the upper edge of the sliding sash. If an additional insect screen is not provided, the filter mat may be suspended on both sides of the sliding sash, i.e., on its outer side and on its inner side.

On the other hand, if an insect screen is provided, the free lower edge of the insect screen or a horizontal rod fixed thereto should preferably be suspended or suspendable in the area of the inner side of the upper edge of the sliding sash. The filter mat is then preferably situated on the outer side of the sliding sash.

As the result of all superposed, movable window panes of the sliding window being an integral part of a single sliding sash, which for opening may be lowered vertically downwardly as a whole, a seal which must otherwise be provided between multiple sliding sashes is dispensed with. It is much easier to seal off a single sliding sash from a stationary frame, in particular against driving rain as well as drafts, than multiple sliding sashes that are movable relative to one another and also relative to a frame. In addition, the guide mechanism and optionally the drive mechanism are simplified.

A strictly vertical sliding movement of the sliding sash, i.e., without any tilting or outward swiveling movement, is preferred.

The arrangement according to the invention thus facilitates the use of only a single window sash within an entire window frame; a division of the overall glass surface into multiple window sashes is not necessary. Accordingly, horizontally extending transoms or vertically extending mullions may be dispensed with entirely. If necessary for oversized, for example particularly wide, windows, in particular for widths of 1.50 m or greater, a division into multiple sliding sashes may take place, for example by means of mullions situated in between.

Many different types of flat glass may be considered for lowerable window panes: float glass and/or glass with special properties, such as single-pane safety glass or thermally tempered glass, and/or glass panes with a special structure, such as laminated glass and laminated safety glass, multipane insulating glass, or wired glass, and/or window panes with special coatings such as self-cleaning glass, solar control glass, or intelligent glass. Glasses having different properties may be joined together to form glass panes having various structures, and completed as window panes having various coatings.

An example of a standard flat glass that is usable within the scope of the invention is float glass, which is manufactured in the float process, which results in particularly smooth surfaces.

In addition, single-pane safety glass (SPSG) that is thermally tempered may be used for the invention. For the latter, a nonhomogeneous cooling process results in compressive stresses in the more rapidly cooled surface, and tensile stresses in the more slowly cooled interior of the glass. The compressive stresses at the surface impede the formation and propagation of cracks, with the result that the strength and thermal shock resistance of SPSG are significantly better than the corresponding properties of comparable flat glass that does not undergo special thermal treatment.

Thermally tempered glass (TTG), which is likewise thermally tempered, is also suitable for the present invention; however, the thermal tempering during manufacture is less pronounced than with SPSG.

The invention may also be implemented using laminated safety glass (LSG), which is made up of alternating layers of glass and plastic film. This type of glass is based on the concept that in the event of breakage, the glass fragments or shards adhere to the film(s). Laminated safety glass may be made from combinations of various types of glass such as float glass, SPSG, and/or TTG.

So-called laminated glass, which is made up of at least two panes and organic materials in between, such as cast resin, would likewise be usable.

Multipane insulating glass (MIG), which is likewise usable in the present invention, includes at least two panes and an edge compound with an interpane space that may be filled with gas or air. When two glass panes having different thicknesses are used, such a multipane arrangement has very good sound-insulating properties.

Within the scope of the invention, wired glass may also be used, i.e., a glass in which, during shaping by rollers, a wire lattice is inserted into the formed glass ribbon, which imparts breakage-resistant properties to the glass pane in quantity, thus making it practically burglar-proof.

Window panes having self-cleaning properties may also be used. These may be provided with a self-cleaning coating on their outer side, for example a coating according to the so-called “lotus effect.”

Other types of glass are also suitable, in particular sound insulation glass, safety glass, and coated glasses of all types.

The window panes according to the invention may also be combined with solar protection, in particular by using a solar control glass that is provided, at least in areas, with an absorbent and/or reflective coating, in particular on the respective outer side.

Lastly, so-called “intelligent glass” is also now available, i.e., electrically switchable glass whose light transmittance can be changed by applying a voltage. In such an arrangement, the use of a roller shutter or louver blind is unnecessary. The coating itself may be selectively switched, in the manner of a liquid crystal display, between transparent or bright on the one hand and opaque or dark. In principle, according to the invention a glass having such a coating may be integrated into a product.

It has proven advantageous for the at least one lowerable window pane to have a movable frame that is connected to the glass pane(s), or to be designed without a frame. In particular for glass panes or window panes such as laminated glass, laminated safety glass, or multipane insulating glass, which are made up of multiple layers, a frame may be used to stably join these layers together.

The free lower edge of an insect screen, which may be unwound from a roller installed above the closed sliding sash, may be suspended or suspendable on the upper edge of the sliding sash. Such an arrangement offers the advantage that in the suspended state, the insect screen is pulled out only exactly as much as necessary to impenetrably close off the clearance opening for insects that is created by opening the window pane, wherein a clear view through the closed or not totally open pane remains. Thus, if the sliding sash is moved, whether by hand, by mechanical means, or by a motor, the insect screen always follows this movement and closes off the particular free space above the lowerable sliding sash.

The insect screen may preferably be suspended over the entire width of the window sash, for example by means of mutually engaging horizontal, undercut profiles, so that no gap through which insects could penetrate into a room remains at this location. Such a purely mechanical form of suspension is the simplest and most secure. Of course, other connections could also be considered, for example by means of magnetic force, by mounting on an element, for example on an end-side rail of an insect screen, a magnetic bar or magnetic strip that cooperates with a preferably ferromagnetic strip on the other element, for example at the upper edge of the sliding sash, but is still detachable at any time simply by pulling the two elements apart.

In one advantageous refinement of the invention, a roller from which the insect screen may be unwound is supported in the upper area of the guide frame. This roller as well as the insect screen that is wound onto it is thus likewise an integral part of the installation unit according to the invention, which simplifies or facilitates the installation.

The roller accommodating the insect screen should be pretensioned by a spring element in a rotational direction such that the spring element seeks to wind up the insect screen. As a result, on the one hand the insect screen is always held under tensile stress, and on the other hand also winds back up automatically when the window is closed.

Continuing further with the inventive concept, a (preferably additional) roller from which a roller shutter, a roller blind, or a louver blind may be unwound may be supported in the upper area of the guide frame. A shading device for the window is thus also integrated into the unit according to the invention, and therefore no longer has to be retrofitted on site.

According to another design rule, at least one guide groove for the guiding accommodation of each side edge of the roller shutter, roller blind, or louver blind is incorporated into each of the two lateral sections of the guide frame, wherein the slotted openings of these two guide grooves lie in a shared vertical plane parallel to the plane of the vertical sliding window, and face one another. This ensures that a flat shading means is guided along its two side edges parallel to the window pane.

The lateral guide grooves for a roller shutter may be situated on the outer side of the countersinkable window pane(s). In this case, the closed, stable roller shutter curtain is situated outside the window, in front of same, thus providing additional anti-burglary protection.

It is also possible for the lateral guide grooves for a roller blind or a louver blind to be situated on the inner side of the countersinkable window pane(s). These somewhat fragile shading devices are less suited for anti-burglary protection, and may be protected from external influences, such as wind, rain, snow, or hail by the window pane according to the invention.

In addition, according to the teaching of the invention, a panel made of a transparent material is provided in the upper area of the window opening, preferably on the outer side, to allow gap ventilation that is not impaired by driving rain.

If the box accommodating the lowered sliding window is not transparent, in any case an upper edge strip is still visible from the completely lowered window pane, and therefore also cannot be damaged. This is because a stable box made of a hard plastic or even a metal provides the lowered window pane with optimal mechanical protection from damage. Lastly, for good measure this box may be inserted into masonry, where it is protectively surrounded, in particular also on its two flat sides.

In one refinement of the invention, the box accommodating the lowered sliding window is connectable or connected to or integrated into an upper guide frame that accommodates the closed sliding window. By fixedly joining these elements, it may be ensured that a glass pane while being lowered always finds guide tracks that extend along a straight course and are mutually aligned, and thus can neither break nor tilt.

At least one guide groove for the guiding accommodation of each side edge of the lowerable window pane may be incorporated into each of the two lateral sections of the guide frame, wherein the slotted openings of these two guide grooves lie in a shared vertical plane parallel to the plane of the vertical sliding window, and face one another. The width of these slots depends on whether or not the movable window pane is mounted in a frame. In the former case, the slot width must correspond to the frame thickness, and in the latter case, the slot width only has to correspond to the overall thickness of the movable window pane itself, optionally together with a sealing profile provided for sealing.

Seals are preferably provided in the area of slotted openings in which/through which the window pane and/or its frame slides, on the inner and/or outer side of the window pane or the frame, to prevent penetration of water, drafts, or the like. Such seals preferably extend in the longitudinal direction of the slot section in question, and may be situated in the area of the particular outer edge of the slot or moved into same. The sealing lips of these seals that are fixed at the slotted openings preferably rest against the window pane or its frame; the cross section through such a sealing lip preferably extends not perpendicularly with respect to the window panes or frame surface in question, but, rather, obliquely thereto, or is pressed against the surface in question due to the inherent elasticity of the cross section, wherein the sealing lip in its cross section may optionally bend tangentially with respect to the surface in question. The pressure conditions may be different, depending on whether winds or gusts are present outside the building; on a side of the building facing the wind, the external pressure may be greater than the internal pressure, and on a side facing away from the wind may be lower due to suction effects. For this reason, two seals, one outside the window pane and one inside the building, complement one another, wherein, for example, the seal facing the positive pressure is pressed more strongly against the window pane or its frame, thus further improving the sealing effect for an acting positive pressure.

According to the invention, it is recommended that the box accommodating the lowered sliding window has a further, flat chamber for holding insulation, in particular thermal and/or acoustic insulation. This measure allows the reduced insulation capability of the chamber itself to be compensated for by an additional insulation layer parallel to the plane of the window. Simple materials such as mineral wool, as well as Styrofoam or so-called vacuum insulation panels, are suitable as insulation. The insulation layer is preferably situated on the flat side of the chamber that faces the outer side of the building; however, in certain cases this could be different, or insulation could be dispensed with entirely, for example for buildings in countries near the equator.

Due to the downward lowering movement of the window pane, the counterweights, which are usually present for sliding sashes that are to be raised upwardly into the open position, may be dispensed with. On the one hand this reduces the complexity, and on the other hand saves installation space, in particular within the chamber according to the invention, in which no counterweights are now to be housed, although such a measure would of course be additionally possible. According to the invention, however, these counterweights would have to be raised for opening the sliding sash, and lowered for closing it.

However, as further provided by the invention, if such counterweights were nevertheless provided and were designed to be heavier, in particular slightly heavier, than the sliding sash together with the glass panes, they could automatically close the sliding sash, for example after releasing a lock, in particular even without auxiliary energy. A catch could then be provided to arrest the opened sliding sash, until the catch is released, for example by a timer, and the counterweights then no longer hinder pulling the window into its closed position. Such a timer could, for example, be a preferably mechanical clock that is windable and/or settable to a certain time interval, similarly, for example, to a countdown timer, also referred to in another design as an egg timer, that runs backwards from an initially set time interval, such as “10 minutes,” and when it returns to the time value of zero, releases the catch and thus allows the counterweights to close the sliding sash. Any given ventilation time may thus be set, and the window automatically closes after the particular time interval elapses.

However, one refinement of the invention is preferred in which a drive for raising and/or lowering the lowerable window pane(s) is situated in the chamber of the box accommodating the lowered sliding window or in a further flat chamber of the box that is parallel to the first chamber. Use of such a mechanical drive ensures that the window pane is always raised or lowered at an approximately optimal speed. Although such a drive could have a purely mechanical design, and thus be operable by hand, for example, via a crank, for instance, or with the above-described counterweights, this would allow the sliding sash only one direction of movement; however, it is preferred to use an activator that is operable with auxiliary energy, such as a motor that is operated by electrical, electronic, magnetic, pneumatic, or hydraulic means, or also a cylinder that is pneumatically or hydraulically activatable, etc.

Such an activator having a self-locking design, for example a motor, which when stopped is able to apply a sufficient braking torque, may then completely replace counterweights, thus providing more space in the chamber for mechanical transmission elements of the drive device or the like. In contrast to the purely mechanical closing mechanism indicated above for reclosing the sliding sash after a settable ventilation time, a motorized drive device has the advantage that it is typically usable in both directions, i.e., closing the sliding sash and opening it, and may also replace a mechanical brake. The window may then be closed or opened at any desired time via a controller.

According to the invention, it may be provided that the drive has one, two, or more vertical toothed rack(s) that is/are connected or connectable to the lowerable window pane(s). A pinion having a horizontally oriented rotational axis may in each case mesh with a toothed rack in order to move the window pane via a joint exertion of force on all toothed rack(s) with an overall moderate level of effort.

The drive may optionally have one or more vertical threaded spindle(s) that is/are connected or connectable to the lowerable window pane(s). A pinion having a vertically oriented rotational axis may in each case mesh with gearing on the lower end of a threaded spindle in order to move the window pane via a joint exertion of force on all threaded spindle(s) with an overall moderate torque.

The invention may also be implemented in such a way that the drive has one or more vertical traction element(s) that is/are connected or connectable to the lowerable window pane(s). A spool or drum, preferably having a horizontally oriented rotational axis, may in each case selectively wind or unwind a traction means in order to raise or lower the window pane via a joint exertion of force on all traction means with an overall moderate force.

For a motorized or automatic drive of the sliding sash, at least one energy converter may be provided for converting supplied auxiliary energy into a mechanical movement, for example an electric or hydraulic motor or a hydraulic or pneumatic cylinder.

In addition, the drive of the sliding sash may be coupled to control, regulation, and/or monitoring which automatically bring(s) about closing or partial or complete opening of the sliding sash during deteriorating weather conditions, in particular associated with wind, rain, and/or cold. In addition, as an integral part of a central anti-burglary protection system, the windows according to the invention could be closed upon leaving and locking the building or living space in question. In addition, a room monitor could be used to detect a low oxygen level or increased humidity in the interior in question, and the sliding sash could then be opened to a certain extent to allow air exchange, possibly only for a predefined period of time to prevent the interior in question from cooling down.

### BRIEF DESCRIPTION OF THE DRAWINGS

Further features, particulars, advantages, and effects based on the invention result from the following description of one preferred embodiment of the invention and with reference to the drawings, which show the following:

FIG. 1 shows a sliding window according to the invention in a vertical section transverse to the plane of the pane, which by way of example is driven by a type of scissor linkage;

FIG. 2 shows an enlargement of detail II in FIG. 1; and

FIG. 3 shows an alternative drive for the sliding window according to FIG. 1 in a schematic illustration, in a viewing direction perpendicular to the plane of the pane.

### DETAILED DESCRIPTION OF THE PREFERRED EMBODIMENTS

The aim is for a sliding window 1 according to the invention to eliminate the disadvantages of conventional windows. For this purpose, multiple elements are combined into a unit.

The key component is a window pane 2, which may be made up of multiple glass panes, for example two or three glass panes, that are joined together. These panes may optionally also be separated by one or more cavities, thereby improving the thermal and/or acoustic insulation capability.

This window pane 2, or optionally the plurality of glass panes that comprise it, is preferably mounted in a sash frame 3. However, this is not absolutely necessary. A single glass pane or a window pane 2 made up of joined-together glass panes could also be used without directly joined frames.

The sash frame 3 may be situated all the way or only partially around the periphery of the window pane 2.

An upper horizontal bar 4 of the sash frame 3 preferably extends along the upper edge 5 of the window pane 2, and/or a lower horizontal bar 6 of the frame 3 extends along the lower edge 7 of the window pane 2. These two horizontal bars 4, 6 may be joined together by lateral struts, which, however, is not mandatory if the bar(s) 4, 6 is/are fastened to the window pane 2 in some other way.

The sash frame 3 is also suitable in particular as an engagement point for a sliding device that is driven manually or by motor. Without such a sash frame, punctiform, for example bracket-shaped, receptacles for the window pane 2 on a motor-driven sliding device are also sufficient for transmitting force into the window pane 2.

The overall entity made up of the window pane 2 and all parts 4, 6 of the sash frame 3 that are fixedly connected thereto form the sliding sash 8. Of course, the sash frame 3 of the sliding sash 8 could also have muntin bars that either may be superimposed, or that actually divide the sash frame 3 into multiple surfaces or openings into which a window pane 2 is inserted in each case. However, such a measure would generally be provided more for esthetic than for functional reasons.

In order for the sliding sash 8 to be vertically displaceable, its side edges, i.e., the side edges of the window pane 2 when a sash frame 3 is absent, or in the case of an incomplete sash frame 3, the end-face sides of the horizontal bars 4, 6, or for a complete sash frame 3, its vertical lateral stiles or struts that join the horizontal bars 4, 6 together, are height-adjustably accommodated in two lateral guide rails 9 of a window frame 10.

The window casing 10 surrounds the sliding sash 8 around its entire periphery. The sliding sash may be made of any desired material and may have any given shape and thickness. Illustrated as an example are two lateral uprights, mullions, or window casings 11 that accommodate the guide rails 9; these may be connected above and below the closed sliding sash 8 via a cross strut in each case. An upper leg or an upper closure element 12 connects the two mullions 11 above the sliding sash 8, while the lateral mullions 11 are connected by a weather guard and/or a window sill and/or a lower closure element 13, in particular at a distance below the upper closure element 12 that corresponds approximately to the height of the window pane 2.

The lower closure element 13 is preferably not designed as a pure crossbar, and instead may have a flat, preferably rectangular extension whose height corresponds to the height of the window pane 2.

A flat closure element 13 having a carrier plate for plaster 52 or some other plate-shaped facade material or also having a viewing surface may be provided on the inner and/or outer flat side.

This closure element 13 accommodates a chamber-like cavity 14. This cavity extends over the entire, or essentially the entire, height of the lower closure element 13, its width corresponds to the distance between the guide rails 9, and its depth extension perpendicular to the plane of the sliding sash 8 corresponds at least to the width of the guide slot of a guide rail 9. Due to its dimensions and the inner chamber 14, the lower closure element 13 resembles a box.

The chamber-like cavity 14 is open at its top side, and at that location has a slotted opening 15 through which the sliding sash 8 can slide. The slotted opening 15 may be sealed off by two lateral sealing strips 53, which may be fixed at the top side 16 of the lower closure element 13 as well as on the side, and/or at the longitudinal edges of the upper slotted opening 45.

Since the two guide rails 9 extend into the chamber-like cavity 14 and continue therein, the sliding sash 8 may be lowered into the chamber-like cavity 14 so that the window pane 2 completely or essentially completely disappears.

The window pane 2 could be raised once again manually, provided that a handle is provided for this purpose on the upper horizontal bar 4 of the frame 3 of the sliding sash 8, or by means of a crank via a crank drive.

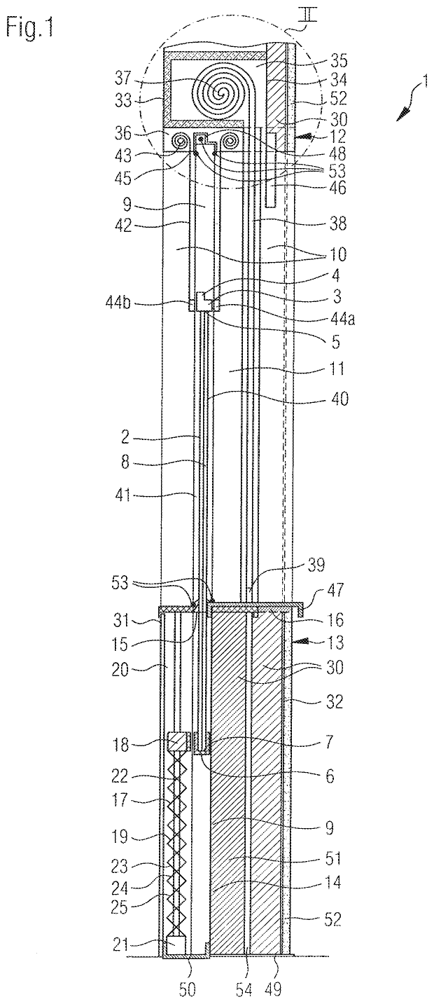

On the other hand, a drive mechanism 17 may also be provided to once again raise the window pane 2 and thus close the window opening. Such a drive mechanism 17 is shown in FIG. 1, situated in an extension of the chamber-like cavity 14. As is apparent in FIG. 1, for this purpose the extension of the chamber 14 perpendicular to the plane of the sliding sash 8 may be greater than the thickness of the window pane 2 or a sash frame 3 surrounding it. There is one or, preferably in the area of both sides of the lowered window pane 2, one each, of a vertically adjustable element 18 that is coupled, for example connected, to the frame 3 of the sliding sash 8.

FIG. 1 illustrates by way of example a scissor-like drive, i.e., a type of “lazy tongs” 19 with an upwardly directed deployment direction. These lazy tongs connect a lower anchoring part 21, fixed at the base of the lateral chamber extension 20, to the upper, vertically adjustable element 18. By moving the two lower legs 21 of the lazy tongs 19 together or apart, they are retracted downwardly or extended upwardly, in each case taking the sliding sash 8 with them via the vertically adjustable element 18. The articulated joints 22 between the individual legs 23, 24 of the lazy tongs 19 may be additionally guided in lateral guide rails 25 to prevent the lazy tongs 19 from twisting.

Other forms of the drive mechanism 17 are conceivable. Thus, one or more vertical rotary spindles with a circumferential thread may be provided, on which in each case a block-shaped part with a matching female thread is adjustable by screw. When this block-shaped part is secured to the frame 3 of the sliding sash 8 and thus nonrotatably fixed, the rotary spindle itself may be set in rotation about its vertical rotational axis. In this way, the block-shaped part screws in upwardly or downwardly along the rotary spindle, depending on the rotational direction of the rotary spindle at that moment. In addition, with such a drive mechanism 17 the desired closing and opening motion of the sliding sash 8 could thus be brought about.

A further option for a drive mechanism 17′ is depicted in FIG. 3. Two toothed racks 26 are apparent which are fastened to lateral vertical struts of the sash frame 3, preferably in the area of the guide rails 9, so that the toothed racks are concealed by the struts and thus are not visible from the outside. Provided in the area of the chamber 14 or its extension 20 are gearwheels 27, which are engaged with a toothed rack 26 in each case, and whose rotational position influences the vertical displacement of the toothed racks 26. As illustrated in FIG. 1, the two gearwheels 27 may be coupled via shafts 28 to a shared drive motor 29, optionally with a gear situated in between, for joint, synchronous rotary adjustment.

Another embodiment of the drive mechanism 17, not illustrated in the drawing, could be based, for example, on chain-like traction elements that are connected to the frame 3 of the sliding sash 8 in the area of a chain link. These could be two chains that are each self-contained and thus continuous, with an upper and a lower deflection chain wheel. A synchronous drive is ensured, for example, by coupling a pair of such mutually aligned deflection chain wheels in a rotatably fixed manner to one another or to a shared drive motor.

For all drive mechanisms 17 there is the option in each case to provide two lateral drive means; in this case it must be ensured that the lateral drive means run synchronously with one another. In the embodiment according to FIG. 3, this is achieved by a design with shared coupling elements such as the shafts 28. For scissor-type drives or spindle drives, a mechanical coupling may also be established by means of such synchronizing shafts. There is also the option for an electrical coupling, for example by providing each of the two drives with a rotary encoder and synchronizing the drive motors by control means, so that the signals of the rotary encoders are always kept synchronous during raising and lowering of the sliding sash 8.

This type of synchronization is dispensed with when only one drive means is used. However, a single drive means should then be centrally situated between the two guide rails 9 so that the sliding sash 8 cannot tilt or jam. However, a central arrangement with the toothed rack drive 17′ according to FIG. 3 is not possible for esthetic reasons, since in such a case a toothed rack 26 would have to extend centrally across the glass pane. The toothed racks 26 are preferably situated in the area of the lateral guide slots of the window casing so that they are concealed. Other drive or gear elements may also be situated in the area of such guide slots, such as tension wires, chains, or other traction elements.

In all cases, the drive mechanism 17, 17′ is equipped with a drive motor, preferably an electric motor, that is switched in one rotational direction or the other, depending on the desired actuation direction. This may be specified by selecting one of two actuating switches. Thus, a double rocker switch or button, as also used for raising and lowering electric roller shutters, may be provided as the actuating switch. In addition, a raising or lowering movement may be stopped by means of limit switches when an upper and/or lower end position is reached.

The auxiliary energy for raising or lowering the window pane may be supplied electrically, electronically, hydraulically, or magnetically, depending on the design of the drive unit. If the window is to be openable even in the event of a power failure, for example in an emergency situation, unlocking may be provided, which upon mechanical triggering moves the window pane, optionally together with a frame accommodating same, downwardly under its weight force and/or with manual assistance, so that an escape route is provided.

It is also apparent in FIG. 1 that flat insulation 30 may also be provided in the area of the lower closure element 13, in particular to thermally compensate for the rather unfavorable thermal insulation properties of the open hollow chamber 14, optionally together with the extension 20. The insulation 30 situated behind a carrier plate for plaster 52 may be provided with a plate-shaped intermediate layer 54 as acoustic insulation and/or anti-burglary protection, for example in the form of a cement-bonded plate or a metal plate.

The entire window casing 10 made up of the two lateral mullions 11, the upper closure element 12, and the lower closure element 13 is anchored in the masonry and is used for vertically guiding the sliding sash 8.

For this purpose, the entire lower closure element 13 is also inserted into the masonry and fixed there. To this end, the height of the wall recess clearance should be greater than that of the sliding sash 8, namely, approximately two times greater, so that not only the upper part of the window casing 10 fits into the wall recess, but so does the lower part, which once more is practically the same size, made up of the lower connecting element 13 with the chamber 14 for accommodating the open sliding sash 8. Accordingly, a wall recess that is suitable for this purpose resembles a door aperture, and extends downwardly much farther than the subsequent window opening, ideally down to the floor of the room in question, and/or in the form of an opening that is ceiling-high or that even extends beyond the ceiling level, for example to allow a tall window pane, whose height exceeds one-half the ceiling height, to be completely lowered.

As is also apparent from FIG. 1, there is an option to design the lower closure element 13 to be much thicker, in a direction perpendicular to the plane of the window, than the lateral mullion 11 of the window frame 10. The thickness of the lower closure element 13 may approximately correspond to the thickness of the wall shell. On its large, inwardly pointing flat side 31 as well as on its outwardly pointing flat side 32, the lower closure element 13 may be additionally provided with a surface 52 that is suitable as a plaster base, or even directly as the visible side. As a result, it is no longer necessary here to wall in the lower closure element 13; at most, filling in the gap area between the window casing 10 and the wall reveal is sufficient. Otherwise, the lower closure element 13 may be smoothly plastered over.

In addition, the lateral sections of a sliding window element 1, generally referred to as window casings 10, may be provided with a surface 52 that is suitable as a plaster base on their inner side facing the room and/or on their outer side facing the building facade. Metal surfaces as well as plastics, such as (colored) acrylic glass, are examples of suitable visible surfaces.

The situation is similar for the upper closure element 12. Here as well, the upper closure element may be designed to be much thicker, in a direction perpendicular to the plane of the window, than the lateral mullion 11 of the window casing 10, for example exactly as thick as the lower closure element 13, and on its inner and/or outer flat side 33, 34 may likewise be provided with a surface that is suitable as a plaster base, so that at this location as well, it is not necessary to wall in the upper closure element 12, and filling in the gap area between the window casing 10 and the wall reveal is sufficient. Otherwise, the upper closure element 12 may also be smoothly plastered over.

Such an upper closure element 12 with a thickened design may also have one or more chambers 35, 36 in its interior for accommodating further functional elements.

In such a chamber 35, on the one hand there is space for a shaft 37, extending in the horizontal direction parallel to the upper closure element 12, for winding up a roller shutter curtain 38, which in the unwound state may be guided downwardly in lateral guides 39 that extend along the mullion 11 to the upper closure element 13. The guides 39 for such a roller shutter curtain 38 are preferably situated at the outer side 40 of the sliding window 1. The shaft 37 may be drivable by hand or by motor for winding and unwinding the roller shutter curtain 38.

Alternatively or additionally, a similar mechanism for winding and unwinding a roller blind or a mechanism for raising and lowering a louver blind could be provided at the inner side 41 of the sliding window 1. These elements in the wound-up or raised state may also be accommodated in a chamber in the area of the upper closure element 12. The winding and unwinding or raising and lowering may be carried out by hand or by motor. A motor, in particular an electric motor, may be an integral part of an automatic control, so that the closed state of a roller shutter or roller blind may be controlled, even in the absence of a person, according to the time of day and/or according to the position of the sun.

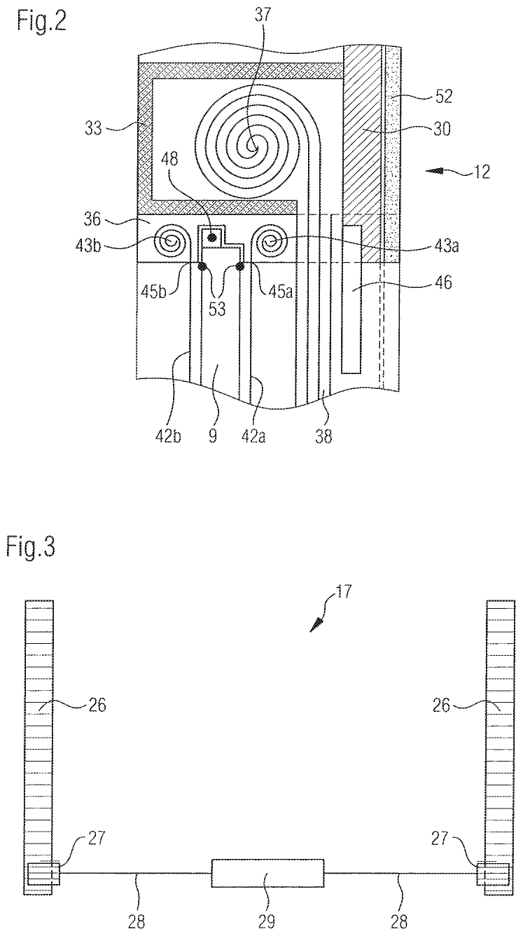

FIG. 2 illustrates a filter mat 42a as a further functional element, which may be wound onto and unwound from a further shaft 43a within a chamber 36 in the upper closure element 12.

The shaft 43a for this filter mat 42a may be pretensioned by a spring element, in particular in a rotational direction that is suitable for winding up the filter mat 42a, so that the filter mat 42a by itself is pulled upwardly and wound up.

A horizontally extending crossbar 44a which is thicker than a slotted opening 45a in the upper closure element 12, through which the filter mat 42a exits downwardly from the chamber 36 in question, may be situated at the lower end of the filter mat 42a. Completely winding up the filter mat 42a may be avoided in this way.

Elements of a detachable connection whose counterparts are situated on the upper horizontal bar 4 of the sliding sash 8 may be provided on such a crossbar 44a in the area of the lower end of the filter mat 42a. As a result of these connecting elements, the crossbar 44a in the area of the free lower edge of the filter mat 42a may be connected to the horizontal bar 4 in the area of the free upper edge of the sliding sash 8.

When the sliding sash 8 is opened, at the same time the filter mat 42a is thus always unwound from its shaft 43a and pulled off, in each case to the extent that the clearance opening above the sliding sash 8 is completely closed by the filter mat 42a, and insects therefore cannot penetrate through the window 1. When the sliding sash 8 is closed, the spring element situated on the shaft 43a always pulls the filter mat 42a as far upwardly as possible, and also always holds it tautly so that it cannot flutter, even in the event of a wind gust.

The filter mat 42a preferably extends in two lateral guides which tightly engage around it and thus prevent flow around the filter mat 42a.

The shaft 43a, the lateral guides for the filter mat 42a, and the crossbar 44a are preferably situated on the outer side of the sliding sash 8, so that a filter mat 42a that is loaded with suspended particles is washed clean by rain.

On the one hand, an insect screen 42b may also be provided, which in the unused state is wound onto a shaft 43b, and which on its free end may be provided with a crossbar 44b and may run in lateral guides. The arrangement of the insect screen 42b, its shaft 43b, and its lateral guides is preferably a mirror image of the filter mat 42a and its shaft 42a and its guides, with respect to the window pane as a plane of symmetry.

The shaft 43b for the insect screen 42b may also be provided with an integrated spring that seeks to wind the insect screen onto the shaft 43b when the window is closed. The crossbar 44b prevents the insect screen from being inadvertently pulled through a slotted opening 45b in the upper closure element 12.

To provide gap ventilation with protection from driving rain when the window pane 2 is only partially open, the invention also provides a panel 46 made of glass or acrylic glass that is placed in front of the upper area of the window opening. Since the panel 46 placed in front is transparent and also is situated only in the upper area of the window opening, the transmission of light is only marginally impaired. By use of a specialized electrical circuit, the allowable open position of the window pane 2 under the assumption of “protection from driving rain” is controlled in such a way that it is adapted to the existing structural and country-specific criteria; in areas with intense storms, the allowable settable gap width would be much narrower than, for example, areas with less severe weather.

The outer upper face of the lower closure element 13 is protected by a window sill 47 made of aluminum or some other water- and UV-resistant material.

In addition, for purposes of personal protection, for example, a contact strip 48 may be applied, for example in the upper inner area of the upper closure element 12, which when pressed causes the window pane 2 to remain in any desired position, for example to prevent persons from being pinched.

Such a function for immediately immobilizing the window pane 2 may also be achieved via other means, for example, with a photoelectric barrier sensor or a laser beam, which when interrupted causes the window pane 2 to be immediately immobilized, or by means of magnetic contacts or other proximity switches which when triggered or closed instantaneously immobilize the window pane 2.

The lower receptacle of the lifting device and of the window pane 2 in the lower area is preferably designed as a watertight trough 50 having a height of several centimeters, and in addition a protective film 51 or a molded part may be situated on the inner side of the outer insulation 30 for repelling water that possibly passes into this watertight trough 50.

To allow water that passes into the cavity 14 or into the chamber extension 15 to drain off, a drain pipe 49 may be provided, preferably in the lower area of the cavity 14 and/or the chamber extension 15, from that location to the outside.

Various refinements of the invention are possible. Thus, the boundary surface 32 of the box 13 facing a room, or a panel 52 mounted at that location, may be prepared for holding a heating element by providing appropriate mounting elements there, etc.

In addition, the insulation 30 could have a tapered design, for example having a thickness of only a few centimeters, so that the boundary surface 32 is recessed into a niche in which space remains for a heating element.

### LIST OF REFERENCE NUMERALS

| | |
|---|---|
| 1 | sliding window |
| 2 | window pane |
| 3 | sash frame |
| 4 | upper horizontal bar |
| 5 | upper edge |
| 6 | lower horizontal bar |
| 7 | lower edge |
| 8 | sliding sash |
| 9 | guide rail |
| 10 | window casing |
| 11 | mullion |
| 12 | upper closure element |
| 13 | lower closure element |
| 14 | chamber-like cavity |
| 15 | slotted opening |
| 16 | top side |
| 17 | drive mechanism |
| 18 | adjustable element |
| 19 | lazy tongs |
| 20 | chamber extension |
| 21 | anchoring part |
| 22 | articulated joint |
| 23 | leg |
| 24 | leg |
| 25 | lateral guide rails |
| 26 | toothed rack |
| 27 | gearwheel |
| 28 | shaft |
| 29 | drive motor |
| 30 | insulation |
| 31 | inner flat side |
| 32 | outer flat side |
| 33 | inner flat side |
| 34 | outer flat side |
| 35 | chamber |
| 36 | chamber |
| 37 | shaft |
| 38 | roller shutter curtain |
| 39 | guide |
| 40 | outer side |
| 41 | inner side |
| 42a | filter mat |
| 42b | insect screen |
| 43a | shaft |
| 43b | shaft |
| 44a | crossbar |
| 44b | crossbar |
| 45a | slotted opening |
| 45b | slotted opening |
| 46 | glass panel |
| 47 | window sill |
| 48 | contact strip |
| 49 | drainage option |
| 50 | watertight trough |
| 51 | seal/film/molded part |
| 52 | panel/plaster |
| 53 | seal |
| 54 | intermediate layer |

1. A vertical sliding window (1) as a closure for an opening in an exterior wall of a building, wherein all superposed, movable window panes (2) of the sliding window (1) are an integral part of a single sliding sash (8), which for opening may be lowered vertically downwardly as a whole, and may be completely or essentially completely countersunk into a flat chamber (14) within a box (13), characterized in that the free lower edge of a filter mat (42a) or a horizontal rod fixed thereto is suspended or suspendable on the upper edge of the sliding sash (8), wherein the filter mat (42a) is suitable for filtering suspended particles such as fine sand, dust, allergens, fine particulate matter, soot, and/or aerosols, and may be unwound from a shaft (43a) installed above the closed sliding sash (8).

2. The vertical sliding window (1) according to claim 1, characterized in that two straight longitudinal edges adjoin the free lower edge of the filter mat (42a) and connect the free lower edge of the filter mat (42a) to the shaft (43a), and in each of which a lateral guide and/or seal extends.

3. The vertical sliding window (1) according to claim 2, characterized in that the lateral guide and/or seal for the filter mat (42a) have/has a U-shaped cross section whose opening faces the filter mat (42a).

4. The vertical sliding window (1) according to claim 3, characterized in that one or both inner sides of the opening of a lateral guide is/are provided with a rubber seal or a brush seal.

5. The vertical sliding window (1) according to claim 1, characterized in that the free lower edge of an insect screen (42b) or a horizontal rod fixed thereto is suspended or suspendable on the upper edge of the sliding sash (8), wherein the insect screen (42b) may be unwound from a shaft (43b) installed above the closed sliding sash (8).

6. The vertical sliding window (1) according to claim 1, characterized in that at least one shaft (43a; 43b) from which the filter mat (42a) and/or the insect screen (42b) may be unwound is supported within an upper, horizontal closure element (12), wherein a shaft (43a; 43b) accommodating the filter mat (42a) and/or the insect screen (42b) is preferably pretensioned by a spring element in a rotational direction such that the spring element seeks to wind up the filter mat (42a) and/or the insect screen (42b).

7. The vertical sliding window (1) according to claim 6, characterized in that the shaft(s) (43a; 43b) is/are displaced perpendicularly with respect to the plane of the window pane.

8. The vertical sliding window (1) according to claim 6, characterized in that the free end of the filter mat (42a) and/or of the insect screen (42b) detaches from the particular shaft (43a; 43b) in an area facing the window pane.

9. The vertical sliding window (1) according to claim 1, characterized by a first shaft (43a) for the filter mat (42a) and a second shaft (43b) for the insect screen (42b).

10. The vertical sliding window (1) according to claim 9, characterized in that the filter mat (42a) is wound onto the first shaft (43a) in an opposite winding direction than the insect screen (42b) is wound onto the second shaft (43b).

11. The vertical sliding window (1) according to claim 9, characterized in that a spring tensioning element for the first shaft (43a) is situated opposite from the spring element for the second shaft (43b) so as to act in a reverse direction of rotation.

12. The vertical sliding window (1) according to claim 6, characterized in that the insect screen (42b) is situated on the inner side of the filter mat (42a).

13. The vertical sliding window (1) according to claim 12, characterized in that lateral guides for the insect screen (42b) are situated on the side of the guides for the filter mat (42a) that face the interior.

14. The vertical sliding window (1) according to claim 6, characterized in that the free lower edge of the filter mat (42a) or a horizontal rod fixed thereto is suspended or suspendable in the area of the outer side or in the area of the inner side of the upper edge of the sliding sash (8).

15. The vertical sliding window (1) according to claim 6, characterized in that the free lower edge of the insect screen (42b) or a horizontal rod fixed thereto is suspended or suspendable in the area of the inner side of the upper edge of the sliding sash (8).

16. The vertical sliding window (1) according to claim 1, characterized in that at least one shaft (37) from which a roller shutter (38), a roller blind, or a louver blind may be unwound is supported in the area of the upper, horizontal closure element (12).

17. The vertical sliding window (1) according to claim 16, characterized in that at least one guide groove for the guiding accommodation of each side edge of the roller shutter (38), roller blind, or louver blind is incorporated into each of the two lateral mullions (11) of the window casing (10), wherein the slotted openings of these two guide grooves lie in a shared vertical plane parallel to the plane of the vertical sliding sash (8), and face one another.

18. The vertical sliding window (1) according to claim 17, characterized in that the lateral guide grooves for a roller shutter (38) are situated on the outer side (40) of the countersinkable sliding sash (8), in particular on the other side of the guide for a filter mat (42a), and/or the lateral guide grooves for a roller blind or a louver blind are situated on the inner side (41) of the countersinkable sliding sash (8), in particular on the other side of the guide for an insect screen (42b).

19. The vertical sliding window (1) according to claim 1, characterized in that a panel (46) made of a transparent material is provided in the upper area of the window opening, preferably on the outer side, to allow gap ventilation that is not impaired by driving rain.

20. The vertical sliding window (1) according to claim 1, characterized in that the at least one lowerable sliding sash (8) has a movable frame (3) that is connected to the glass pane(s), or is designed without a frame.

21. The vertical sliding window (1) according to claim 1, characterized in that the housing of the box (13) accommodating the lowered sliding sash (8) is not transparent, so that in any case the completely lowered sliding sash (8) is still visible along its upper edge strip; when the sliding sash (8) is completely lowered, the upper edge strip may preferably be either completely lowered into the box (13), or protrudes upwardly from the box (13) at most by a narrow region, preferably by a height of not more than 30 cm, preferably by a height of not more than 20 cm, in particular by a height of not more than 10 cm.

22. The vertical sliding window (1) according to claim 1, characterized in that the box (13) accommodating the lowered sliding sash (8) is an integral part of a window casing (10), wherein the movable sliding sash (8) is guided in each position, wherein at least one guide groove or guide rail (9) for the guiding accommodation of each side edge of the lowerable sliding sash (8) is preferably incorporated into the two lateral sections of the window casing (10), and wherein the slotted openings of these two guide grooves or the two guide rails (9) preferably lie in a shared vertical plane parallel to the plane of the vertical sliding sash (8), and face one another.

23. The vertical sliding window (1) according to claim 1, characterized in that the box (13) accommodating the lowered sliding sash (8) has a further, flat chamber for accommodating insulation (30), in particular thermal and/or acoustic insulation (30).

24. The vertical sliding window (1) according to claim 1, characterized in that a drive (17) for raising and/or lowering the lowerable sliding sash (8) is situated in the chamber (14) of the box (13) accommodating the lowered sliding sash (8) or in a further flat chamber or chamber extension (20) of the box (13) that is parallel to this first chamber (14).

25. The vertical sliding window (1) according to claim 24, characterized in that the drive (17) comprises at least one drive element selected from the group consisting of:
a) one or more vertical toothed rack(s) (26) that is/are connected or connectable to the lowerable sliding sash (8); and/or
b) one or more vertical scissor-like drive(s) (19) that is/are coupled or coupleable to the lowerable sliding sash (8); and/or
c) one or more vertical threaded spindle(s) that is/are connected or connectable to the lowerable sliding sash (8); and/or
d) one or more vertical traction element(s) that is/are connected or connectable to the lowerable sliding sash (8).

26. The vertical sliding window (1) according to claim 24, characterized in that the drive (17) has at least one energy converter for converting supplied auxiliary energy into a mechanical movement, for example an electric or hydraulic motor or a hydraulic or pneumatic cylinder.

27. The vertical sliding window (1) according to claim 24, characterized in that the drive (17) of the sliding sash is coupled to control, regulation, and/or monitoring which according to predefined criteria automatically bring(s) about closing or partial or complete opening of the sliding sash (8), for example during deteriorating weather conditions, as an integral part of a central anti-burglary protection system upon leaving the building or living space in question, or when there is a low oxygen level or increased humidity in the interior in question.

28. A vertical sliding window (1) as a closure for an opening in an exterior wall of a building, characterized in that at least one window pane (2) of the sliding window (1) is an integral part of a sliding sash (8), which for opening is downwardly lowerable, in particular into a flat chamber (14) within a box (13).

29. A vertical sliding window (1) as a closure for an opening in an exterior wall of a building, wherein all superposed, movable window panes (2) of the sliding window (1) are an integral part of a single sliding sash (8), which for opening may be lowered vertically downwardly as a whole, and may be completely or essentially completely countersunk into a flat chamber (14) within a box (13), characterized in that the free lower edge of an insect screen (42b) is suspended or suspendable on the upper edge of the sliding sash (8), which may be unwound from a shaft (43b) installed above the closed sliding sash (8).
